(19) United States
(12) Patent Application Publication
(10) Pub. No.: US 2005/0091022 A1
(43) Pub. Date: Apr. 28, 2005

(54) Ultra fast multi-processor system simulation using dedicated virtual machines

(76) Inventors: Konstantin Levit-Gurevich, Kiryat Byalik (IL); Boaz Ouriel, Zichron-Yaacov (IL); Igor Liokumovich, Netanya (IL); Ido Shamir, Kfar-Monash (IL)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/692,946

(22) Filed: Oct. 24, 2003

(51) Int. Cl. G06F 17/50

(52) U.S. Cl. 703/13

(57) ABSTRACT

An apparatus is used to simulate a multiple-processor system by creating multiple virtual machines. The multiple virtual machines may be formed within a single central processing unit (CPU) hardware implementing Virtual Machine Extension (VMX) technology. In an example, the apparatus includes a host environment and a virtual environment that includes the multiple virtual machines. Virtual code may be executed on each of the multiple virtual machines under the control of a direct execution monitor within the host environment. The direct execution monitor may create the virtual machines and control exit and entry thereto. The direct execution monitor may monitor the virtual machines for sensitive events that are to be handled by the host environment, not the virtual environment. The direct execution monitor may determine the nature of the sensitive event, such as whether the instructions associated with the sensitive event should be de-virtualized and simulated separately. The apparatus allows the virtual code to operate as though it is operating on its own dedicate physical processor at a native level.

### FIELD OF THE INVENTION

The present invention relates to microprocessor simulators and, more particularly, to employing direct execution of simulated code on a microprocessor.

### BACKGROUND OF THE RELATED ART

Microprocessor development is no easy task. The evolutionary process from design to commercialization is long and involved. Some manufacturers have developed sophisticated systems to help expedite the process and reduce costs. Yet, the marketplace's desire for increasingly more powerful and complex microprocessor systems continues to challenge manufacturers.

A key barometer in determining whether a new microprocessor design will flourish or flounder is how quickly a large software base is developed for that microprocessor. Existing operating systems, for example, must be ported to the instruction set architecture (ISA) of the new microprocessor and debugged and optimized for use in that ISA. Ideally, this porting would occur early enough so that optimized software would be available upon commercial launch of the new microprocessor. Of course, as experience demonstrates, that is too often not the case.

Software simulators are used to design, validated and tune software for a new microprocessor. The simulators simulate the operation of the new microprocessor and may be used instead of a physical processor, which itself may still be under development. For example, the simulators are used in pre-silicon software development of the basic input/output system (BIOS), the operating system, code compilers, firmware, and device drivers. Simulators are also used to port and debug software applications. Based on the results of the simulations, a designer may modify or verify the new microprocessor design accordingly.

Some simulators may be expanded to simulate the behavior of an entire personal computer (PC) platform, including buses and input/output (I/O) devices. The SoftSDV platform simulator available from Intel Corporation of Santa Clara, Calif. is an example. The architecture of SoftSDV is based on a simulation kernel that is extended through a series of modules, including processor modules and input/output (IO) device modules. With SoftSDV, software developers may select the combination of simulation speed, accuracy, and completeness that is most appropriate to their particular needs, while at the same time preserving the flexibility and maintainability of the overall simulation infrastructure.

The need for increased scale and performance complexity means that both the microprocessor and the software stack executing thereon (including operating systems, compilers, device drivers, etc.) are increasingly more complex in functionality. These performance increases come at a cost to designers. As greater demands are placed on simulators like SoftSDV, more time is needed for the simulation and more processing power is consumed by the simulator. And because these simulators typically run natively on a host CPU, the resources of the host CPU are heavily taxed by complex simulations. In fact, host operating systems (“OS”) assume full control over its machine's resources, which means that if the simulator were also allowed to run natively in the host CPU, resource conflicts between the host OS and simulator would occur over processor time, memory, and device access.

The problems associated with resource conflicts, as well as other simulation factors like accuracy and completeness, would be exacerbated in a multi-processor (MP) system simulator. Designers may wish to simulate a platform with multiple microprocessors or a system offering Hyper-Threading technology (developed by Intel Corporation of Santa Clara, Calif.) and parallel execution of multi-threaded software applications. Yet, in such MP systems, the simulation time increases substantially with the number of microprocessors being simulated or the number of parallel threads attempted.

### BRIEF DESCRIPTION OF THE DRAWINGS

FIG. 1 is a block diagram of an example computer system.

FIG. 2 illustrates a high level architecture of an example simulation environment simulating a multiprocessor system.

FIG. 3 is a flow diagram of an example operation of the architecture of FIG. 2.

### DETAILED DESCRIPTION OF EXAMPLES

Generally, techniques are described for using hardware to simulate multiple-processor (MP) systems, e.g., to assist with porting and debugging software to the systems. The simulation techniques may be used on a single-CPU system that can run a set of virtual machines, one for each simulated processor. The techniques described herein may simulate any number of processors, using virtual machines. The simulation techniques may be executed in a Host code, such as a Host operating system (“OS”) running on the single-CPU system in a Host environment. The simulated code may be executed on the virtual machines, as a Guest code, in a virtual environment, e.g., a Direct Execution environment. The Guest code may be any software stack code, including Guest OS, firmware, device drivers, and applications. The techniques described prevent conflicts between the Host environment and the virtual environment. This allows the Guest code to execute on its virtual machine as though the Guest code were a native code operating on a physical processor.

It will be apparent to persons of ordinary skill in the art that the examples provided may be practiced with the structures shown, as well as with other structures. That is, some of the structures may be removed, replaced, or modified. It will also be appreciated by persons of ordinary skill in the art that, although the descriptions are provided in the context of certain simulation applications, the techniques described herein may be used for other simulation applications.

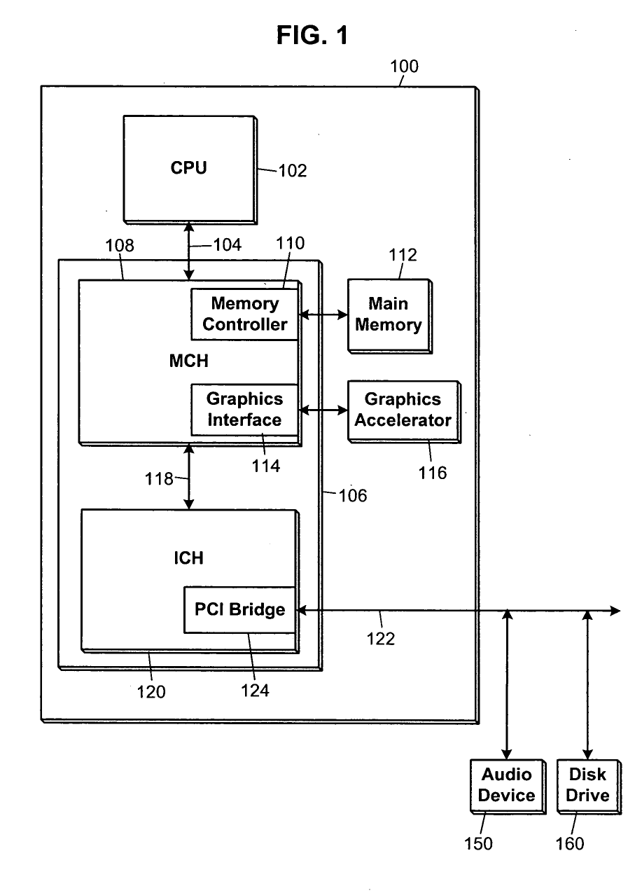

FIG. 1 is a block diagram of an example computer system 100 that may be used to implement the techniques described herein. A central processing unit (CPU) 102 is coupled to a bus 104. The CPU 102 may be an IA-32 processor in the Pentium® family of processors including the Pentium® II processors, Pentium® III processors, Pentium® IV processors, and Centrino® processors available from Intel Corporation of Santa Clara, Calif. The CPU 102 may be an IA-64 processor such as the Itanium™ processor, also available from Intel Corporation.

A chipset 106 is also coupled to the bus 104. The chipset 106 includes a memory control hub (MCH) 108, which may include a memory controller 110 coupled to a main system memory 112 that stores data and instructions that may be executed in the system 100. For example, the main system memory 112 may include dynamic random access memory (DRAM). The memory controller 110 controls read and write operations to the main memory 112, as well as other memory management operations. The bus 104 may be coupled to additional devices, for example, other CPUs, system memories, and MCHs.

In the illustrated example, the MCH 108 includes a graphics interface 114 coupled to a graphics accelerator 116 via an accelerated graphics port (AGP) that operates according to the AGP Specification Revision 2.0 interface developed by Intel Corporation of Santa Clara, Calif.

A hub interface 118 couples the MCH 108 to an input/output control hub (ICH) 120. The ICH 120 provides an interface for input/output (I/O) devices within computer system 100. For example, the ICH 120 may be coupled to a Peripheral Component Interconnect bus 122 adhering to a Specification Revision 2.1 bus developed by the PCI Special Interest Group of Portland, Oreg. Thus, in the illustrated example, the ICH 120 includes a PCI bridge 124 that provides an interface to the PCI bus 122. By way of example, the PCI bus 122 is coupled to an audio device 150 and a disk drive 160. Persons of ordinary skill in the art will appreciate that other devices may be coupled to the PCI bus 122.

Furthermore, other peripheral interface connections may be used in addition to, or in place of, the PCI bridge 124. For example, an interface for a universal serial bus (USB), Specification 1.0a (USB Implementer's Forum, revision July 2003) or 2.0 (USB Implementer's Forum, originally released April 2000, errata May 2002), or an IEEE 1394b standard (approved by IEEE in April 2002) bus may be connected to the ICH 120.

The system 100 of the illustrated example includes hardware that supports LaGrande Technology (LT), developed by Intel Corporation of Santa Clara, Calif. LT supports the creation of a virtual machine on processors.

LT hardware supports two classes of software: Host code and Guest code, i.e., virtual code. The Host code may be the Host OS operating on the CPU 102, which presents an abstraction to the Guest code executed in a virtual machine within the system 100. During the simulation abstraction, the Host code may retain control of the CPU resources, like the physical memory, interrupt management, and input/output device access.

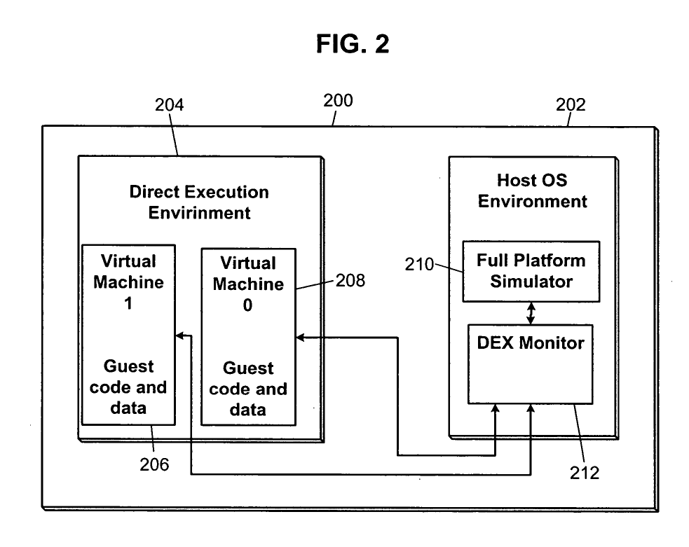

FIG. 2 shows a high level architecture 200 of an example simulation that may run on the system 100. In the illustrated example, the architecture 200 includes, at least a Host OS Environment 202 and a Direct Execution Environment 204, or virtual environment. The Direct Execution environment 204 includes two Virtual Machines (VMs) 206 and 208, each representing a simulated CPU or microprocessor and each capable of running Guest code. Although only two virtual machines are depicted, any number of virtual machines may be formed in the Direct Execution Environment 204. The VMs 206 and 208 execute Guest code directly on the host CPU using Direct Execution technology.

The Host Environment 202 includes a Full Platform Simulator 210 and a Direct Execution (DEX) Monitor 212. The Full platform Simulator 210 executes on top of the Host code and simulates the behavior of the MP or Hyper-Threading system. A SoftSDV simulator with Direct Execution and LT technology, developed by Intel Corporation of Santa Clara, Calif., may be used as the Full Platform Simulator 210, for example. The DEX Monitor 212 communicates with the Full Platform Simulator 210 and bridges the Host Environment 202 and the Direct Execution Environment 204. In an example, the DEX Monitor 212 creates, configures and controls the VMs 206 and 208. The DEX Monitor 212 may have system-level privileges and/or user-level privileges.

The VMs 206 and 208 are formed by the DEX Monitor 212 in accordance with the Virtual Machine Extension (VMX) technology, a component of the LT standard developed by Intel Corporation of Santa Clara, Calif. VMX enables at least two kinds of control transfers related to these virtual machines: VM entries and VM exits. These control transfers are configured and managed by a virtual-machine control structure (VMCS) and executed by the CPU 102.

After the VMs 206 and 208 have been created, sensitive events (if configured in VMCS) may cause an exit from the VM 206 and 208. With VM entries (specified explicitly by a VMX instruction), control is transferred from the Host Environment 202 to the Direct Execution Environment 204. With VM exits, control is transferred from the Direct Execution Environment 204 to the Host Environment 202.

VM exits occur when the VM 206 or the VM 208 attempts to perform some sensitive event (also termed a Virtualization Event), e.g., an instruction or operation to which the attempting virtual machine does not have privileges or access. Virtualization events include hardware interrupts, attempts to change virtual address space (Page Tables), attempts to access I/O devices (e.g., I/O instructions), attempts to access control registers, and page faults. This list is by way of example only. The architecture 200 may define any desired event as a Virtualization Event.

The DEX Monitor 212 may include or access a list of Virtualization Events. The DEX Monitor 212 may also include or access a list of state data, or components, to be loaded or restored upon VM exit or VM entry.

Upon VM exit, the DEX Monitor 212 may perform a state synchronization to transform the original components of the virtual machine to components that will be executed in the Host Environment 202. For example, the DEX Monitor 212 manages Page Tables used in the VM 206 or 208 and may map the Guest code virtual addresses to the physical addresses of the Host memory, e.g., the main memory 112, instead of the ‘physical’ addresses listed by Guest code.

The DEX Monitor 212 also schedules and synchronizes all the VMs 206 and 208. This is achieved by transferring execution to each VM 206 or 208 in turn, using a “round robin” algorithm, for example. Instructions, messages, and data transfers may be achieved among the simulated VMs 206 and 208, as well as between the VMs 206 and 208 and the Host Environment 202.

Further still, the DEX Monitor 212 may establish individual control for each of the VMs 206 or 208, or the DEX Monitor 212 may distribute control between multiple VMs, allowing Guest code to run on multiple simulated processors with the DEX Monitor 212 managing transfers among them. In a Hyper-Threading system, for example, DEX monitor assigns software threads (created by the Guest OS) to separate virtual machines, which simulate separate logical processors.

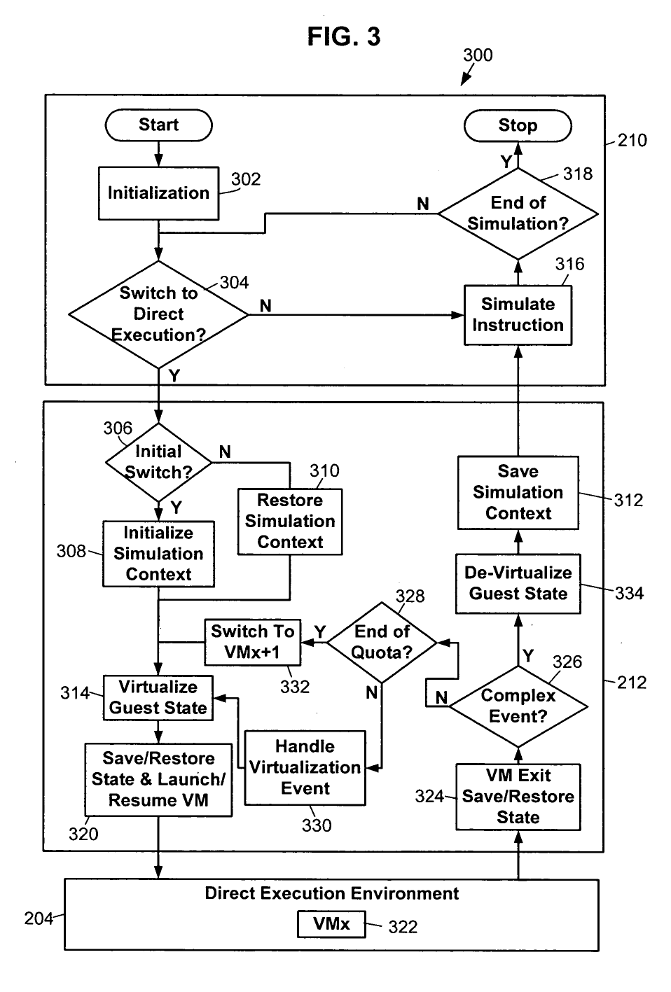

An example operation of the architecture 200 is now described in reference to a simulation process 300. FIG. 3 illustrates an example process 300 that may be implemented by software stored and executed by the system 100. In the illustrated example, the process 300 executes various software routines or steps described by reference to blocks 302-334.

A block 302 within the Full Platform Simulator 212 initializes the process. A block 304 determines if the Full Platform Simulator 210 is to switch from the Host Environment 202 to the Direct Execution environment 204 for executing the simulated instructions code (Guest code) in a virtual machine. If yes, control is passed to the DEX Monitor 212 to allow the simulated instruction codes to execute in a hardware-supported simulation, e.g., the Direct Execution Environment 204, instead of the software simulation of the Full Platform Simulator 210. Through the DEX Monitor 212, the system 100 may perform a full context switch between the Platform Simulator 210 and the Direct Execution Environment 204, allowing Guest code to run in the latter natively, at an original privilege level and at the original virtual addresses.

If the block 304 determines that control of the simulated instruction code is not be transferred to the Direct Execution Environment 204, then the instruction is simulated in the Full Platform Simulator at a block 316 and a block 318 determines if the simulation is to end.

A block 306 determines if this is the first transfer to the DEX Monitor 212. If yes, a block 308 initializes the simulation context (e.g. assigning an execution instructions quota for a simulated CPU). If no, a block 310 restores the simulation context previously saved at a block 312 (e.g., restoring the current executing processor number, its quota, how much of it was used). In either case, control may be passed to a block 314 that virtualizes the CPU Guest state, so that the simulated instruction codes may be executed in the Direct Execution Environment 204. For example, the block 314 may transform, from the host environment to the virtual environment, state data such as general-purpose registers, segment registers, control registers, model-specific registers, debug registers, Interrupts Descriptor Table, Global and Local Descriptor Tables. When running in a virtual machine mode, part of the Guest state has the original values (those intended by the simulated OS of the Platform simulator 210), and other parts have virtualized values, different than the original ones. The virtualization performed by the DEX Monitor 212 may, therefore, be based on the original values of the simulated state.

Back to the block 314, after the Guest state has been virtualized, control passes to block 320, which may save state data associated with the simulated instruction codes from block 314 and, if necessary, create the virtual machines within the Direct Execution Environment 204. The number of virtual machines may be predetermined by the simulator configuration. If the virtual machines have already been created and control is being reverted back to the Virtual Environment 204, for example, after a VM exit and VM entry, the block 320 may re-launch or restore the previously-stored state data.

The block 320 further determines which virtual machine(s) is to receive the Guest code(s), i.e., simulated instruction code(s) to be virtualized, from the block 314. By way of example only, a VMₓ 322 is shown in the Direct Execution Environment 204, where x represents the current virtual machine receiving the Guest code and is an integer between 0 and n−1, where n is the total number of virtual machines and simulated processors accordingly.

Upon a Virtualization Event, a block 324 within the DEX Monitor 212 detects the Virtualization Event and saves the Guest state data. A block 326 determines if the Virtualization Event is a complex event or not. A complex event is an event which the DEX Monitor 212 cannot handle by itself, and therefore has to be transferred to the handling of the Full Platform Simulator 210. If the Virtualization (i.e., exit) Event is not complex, then a block 328 checks if the exit Event was due to the simulated processor end of quota. If block 328 determines that the answer is no, then control is passed to block 330 which executes code to perform a virtualization operation to handle the Virtualization Event within the DEX Monitor 212. Appropriate virtualization operation code may be executed through VMX protocols, for example. The block 330 may perform the simulation needed for handling a non-complex event, which does not have to be sent to the Full Platform Simulator 210. The block 330 then passes control back to the block 314 for Guest state virtualization. If, on the other hand, the answer at the block 328 is yes, then a block 332 switches the DEX Monitor 212 to control of the next virtual machine VMₓ₊₁, for example, in a “round robin” manner. Control is then passed to the block 314.

Instead, if the block 326 determines that the Virtualization Event is a complex event, control is passed to block 334 which de-virtualizes the Guest state back into simulated instruction code(s). In an example, this may be done by managing Page Tables used in the VMₓ 322 and mapping the Guest state virtual addresses to the physical addresses allocated in the Host memory, e.g., the main memory 115.

The block 334 passes control to the Full Platform Simulator 210 which simulates the de-virtualized instruction code(s) at the block 316 under. As stated above, the block 318 determines whether there is there are additional simulated instruction codes that are to be executed in the Direct Execution Environment 204. If so, control is passed to the block 304; if not, the process ends.

Person of ordinary skill will appreciate that FIG. 3 illustrates an example implementation only. Numerous alternatives may be made. For example, while a DEX Monitor is shown separately from a platform simulator, the two may be combined together. A DEX Monitor may monitor a Direct Execution Environment for any type of event, including non virtualization events. For example, with the example of FIG. 3, an instruction like a CPUID instruction may be executed in a Direct Execution Environment as a native instruction, or it can create a virtualization event, and be simulated in a software simulator (if it is desirable to have the simulated CPU be other than the host CPU). Further still, a DEX Monitor may switch between simulated virtual machines in a format other than a round robin format (e.g., giving one simulated CPU more execution quota than the others).

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalence.

1. An article comprising a machine-accessible medium having stored thereon instructions that, when executed by a machine, cause the machine to:
execute a host code in a host environment;
create a plurality of virtual machines in a virtual environment;
transfer a virtual code from the host environment to the virtual environment; and
execute virtual code on at least one of the virtual machines.

2. The article of claim 1, having further instructions that, when executed by the machine, cause the machine to:
create the plurality of virtual machines in a direct execution environment; and
execute the host code in a host operating system environment.

3. The article of claim 2, having further instructions that, when executed by the machine, cause the machine to:
provide a monitor within the host operating system environment, wherein the monitor controls entry to and exit from the direct execution environment.

4. The article of claim 3, having further instructions that, when executed by the machine, cause the monitor to:
control transfer of virtual code between the host environment and the virtual environment based on a virtualization event attempted by at least one of the virtual machines.

5. The article of claim 4, having further instructions that, when executed by the machine, cause the monitor to gain control over the virtualization event from the direct execution environment.

6. The article of claim 5, having further instructions that, when executed by the machine, cause the monitor to return execution to the direct execution environment after a virtualization operation.

7. The article of claim 5, having further instructions that, when executed by the machine, cause the monitor to pass control to a platform simulator within the host environment for simulation of the virtualization event.

8. The article of claim 4, having further instructions that, when executed by the machine, cause the monitor to access a list of virtualization events.

9. The article of claim 3, having further instructions that, when executed by the machine, cause the monitor to:
in response to an exit from the direct execution environment, store state data; and
restore the stored state data prior to entry to the direct execution environment.

10. The article of claim 1, wherein the virtual code includes a plurality of virtual codes each executing on a separate one of the plurality of virtual machines.

11. A method comprising:
accessing simulated instruction codes in a host environment operating on a central processing unit (CPU) implementing Virtual Machine Extensions;
launching a plurality of virtual machines in a virtual environment on the CPU;
virtualizing a CPU state associated with the simulated instruction codes; and
executing at least one of the simulated instruction codes on at least one of the plurality of virtual machines.

12. The method of claim 11 further comprising:
detecting an occurrence of a virtualization event in any one of the plurality of virtual machines;
in response to detecting the virtualization event, exiting the virtual environment; and
analyzing the virtualization event.

13. The method of claim 12 further comprising:
determining whether the virtualization event is a complex event; and
if the virtualization event is not a complex event, virtualizing the simulated instruction code associated with the virtualization event.

14. The method of claim 13 further comprising re-entering the virtual environment after the simulated instruction code associated with the virtualization event is virtualized.

15. The method of claim 13 further comprising:
if the virtualization event is a complex event, de-virtualizing the CPU state; and
simulating the simulated instruction code associated with the virtualization event.

16. The method of claim 12, further comprising:
storing the CPU state upon exiting the virtual environment; and
restoring the stored CPU state upon re-entering the virtual environment.

17. A system comprising:
hardware to generate and control a plurality of virtual machines that each are capable of executing simulated instruction code, wherein the hardware is able to create an abstraction of a real machine so that operation of a real operating system on the computer system is not impeded;
a direct execution environment to execute the simulated instruction codes and associated data as virtual codes;
a plurality of virtual machines formed within the direct execution environment; and
a host environment for controlling exit from and entry to the direction execution environment.

18. The system of claim 17, wherein the host environment comprises:
a monitor to generate the plurality of virtual machines and to perform virtualization operations; and
a platform simulator to perform simulations of virtualization events.

19. The system of claim 18, wherein the monitor gains control from the direct execution environment whenever at least one of the plurality of virtual machines attempts to perform a virtualization event.
